(19) United States
(12) Patent Application Publication
(10) Pub. No.: US 2013/0327779 A1
(43) Pub. Date: Dec. 12, 2013

(54) PRESSURE-RESISTANT FLUID ENCAPSULATION

(71) Applicants: Joachim Baudach, Berlin (DE); Tomasz Magier, Berlin (DE); Uwe Schriek, Berlin (DE); Dirk Weissenberg, Berlin (DE)

(72) Inventors: Joachim Baudach, Berlin (DE); Tomasz Magier, Berlin (DE); Uwe Schriek, Berlin (DE); Dirk Weissenberg, Berlin (DE)

(21) Appl. No.: 13/989,855

(22) PCT Filed: Nov. 10, 2011
(86) PCT No.: PCT/EP2011/069829

§ 371 Date: Aug. 19, 2013

(30) Foreign Application Priority Data
Nov. 29, 2010 (DE) 10 2010 062 097.1

(51) Int. Cl. F17C 1/08

(52) U.S. Cl. CPC F17C 1/08
USPC 220/654

(57) ABSTRACT

A pressure-resistant fluid encapsulation has a cast wall made of a first metal. The cast wall is provided with a non-manual mechanical reinforcing element. The reinforcing element is formed of a different material from the first metal of the cast wall.

The invention relates to a pressure-resistant fluid encapsulation with a cast wall of a first metal, in particular aluminum.

It is known from US patent specification U.S. Pat. No. 3,761,651 to provide electric power transmission devices with a metal casing. This metal casing encloses within it electrically conductive phase conductors, which are required to be electrically insulated from the metal casing.

The interior of these metal casings is provided with a pressurized electrically insulating gas, requiring the metal casings to be designed as fluid encapsulations which prevent volatilization of the enclosed electrically insulating gas. The electrically insulating gas is usually subjected to a positive pressure in comparison with the surroundings of the fluid encapsulation.

As the pressure is increasingly raised, the fluid encapsulation, acting as a pressure vessel, must withstand ever greater pressures. As a consequence, the wall of the fluid encapsulation is usually made more and more solid and the mass of the fluid encapsulation increases.

Therefore, an object of the invention is to provide a pressure-resistant fluid encapsulation which has a sufficient pressure retaining strength, while the mass is reduced and the amount of cast material used is less.

According to the invention, this is achieved in the case of a pressure-resistant fluid encapsulation of the type mentioned at the beginning by using at least one reinforcing element which mechanically strengthens the cast wall and is made of a material that is different from the first metal.

Pressure-resistant fluid encapsulations are used, for example, in electric power transmission devices. There, the pressure-resistant fluid encapsulations usually have a tubular basic structure, which is aligned coaxially in relation to a longitudinal axis. It is usual to provide connecting flanges on the lateral surface and on the end faces, to allow phase conductors to be introduced into the interior of the pressure-resistant fluid encapsulation in an electrically insulated manner. The flanges are closed, for example by means of flange covers, or are provided with an insulator lead-through for one or more phase conductors to be led through in an electrically insulated manner. The phase conductors are, for example, supported on the fluid encapsulation by means of solid insulators. The interior of the fluid encapsulation may also be filled with an electrically insulating gas, which, for example, has an increased pressure and consequently forms a compressed-gas insulation. By means of the pressure-resistant fluid encapsulation, a spontaneous volatilization of the gas is suppressed. The pressure-resistant fluid encapsulations are in this case usually produced from cast aluminum, inhibiting the occurrence of eddy currents in a cast wall of the pressure-resistant fluid encapsulation that are induced by current flowing through the phase conductors. Aluminum has a low mass. The provision of a reinforcement on a cast wall of the pressure-resistant fluid encapsulation allows the pressure-resistant fluid encapsulation to be mechanically strengthened. As a result, the cast wall is stiffened, relieving the cast metal. When designing the reinforcement, it must be ensured that no closed conductor loops that could lead to the formation of a path for a short-circuiting current occur around phase conductors through which current flows.

It may also be advantageously provided that the reinforcing element is at least partially embedded in the cast wall.

At least partial embedding of the reinforcing element makes it possible to connect the cast wall intimately to the reinforcing element. It is particularly advantageous in this respect if the reinforcing element is embedded completely in the cast wall, i.e. the cast wall completely encases the reinforcing element. In this case, it should be advantageously provided that the reinforcing element and the cast wall have approximately the same coefficients of expansion.

A further advantageous design may provide that the reinforcing element rests on the cast wall.

Resting of the reinforcing element makes it possible for it to reach around at least a portion of the pressure-resistant fluid encapsulation, and thus to bring about a stiffening of the cast wall from the outside in the manner of a bandage. Such a design is advantageous for retrofitting already existing pressure-resistant fluid encapsulations, in order for example to increase the pressure retaining strength thereof.

It may also be advantageously provided that the reinforcing element runs around in the form of a ring, a short circuit that follows the path of the ring being interrupted by a break or an inhomogeneity of the material.

An annular reinforcing element has the advantage that the axial extent of the ring can be made much smaller in comparison with its radial extent, so that the ring can, for example, be embedded in or placed on a short tubular portion of the fluid encapsulation or can be fastened in some other way. The annular portion of the fluid encapsulation itself only has to be slightly larger. If a break or an inhomogeneity of the material is then provided in the annulus, this prevents the body of the ring from forming a path for a short-circuiting current on the pressure-resistant fluid encapsulation. A break may be created, for example, by interrupting the ring in the form of a slit. However, it may also be provided that a continuous ring runs around uninterruptedly, with an inhomogeneity of the material being brought about by inserting in the ring a material of lower electrical conductivity or a non-magnetic material. For example, it is possible to weld steels of different grades to one another in order to form a continuous ring, an inhomogeneity of the material being created within the annulus by the different electrical properties in order to avoid short-circuiting paths for induced eddy currents.

It is consequently also possible, for example, to allow annular reinforcing elements to be passed through by a current-carrying phase conductor.

It may also be advantageously provided that at least a portion of the surface of the reinforcing element has a surface-increasing structure.

Surface-increasing structures are, for example, formations or profilings of surfaces which make it possible to bring about a good connection between the reinforcing element and the cast material of the cast wall. Such an interconnection makes it possible after forming a pressure-resistant fluid encapsulation with a cast wall and a reinforcing element to prevent a relative movement between the cast wall and the reinforcing element. For example, increased frictional forces between the cast material and the reinforcing element can be transferred via a structured surface of the reinforcing element.

A further advantageous design may provide that the reinforcing element is connected to the fluid encapsulation by means of a fastening means positioned at the ends.

The reinforcing element may extend in any desired way along a laying path. In order to position the reinforcing element on the cast body, it is advantageous to connect the reinforcing element to the fluid encapsulation by means of a fastening element. Fastening means may be, for example, screws, rivets, bolts, protruding shoulders or the like. These fastening means may bring about a fixed-angle interconnection between the reinforcing element and the fluid encapsulation. This is of advantage in particular when it is intended for the reinforcing element to be merely partially embedded or placed on a surface of the cast wall.

A further advantageous design may provide that the different material comprises a metal, in particular steel, or an organic plastic, in particular an aramid fiber, or a glass, in particular a glass fiber.

The use of a material that is different from the cast material provides the possibility of encapsulating the reinforcing element with the cast material, without completely breaking up the structure of the reinforcing element itself. The reinforcing element may, for example, be a further metal, in particular steel; or else, an organic plastic, such as for example an aramid fiber, may be used. Organic plastics have a high dielectric strength in comparison with the cast material, so it is unlikely for eddy currents to occur here. Steels can be obtained at low cost and can be encased with aluminum during casting. Furthermore, it may also be provided that a glass is used, in particular glass fibers, to form the reinforcing element. Glass fibers can be produced in large quantities at low cost, allowing the formation of glass strands, which have a high mechanical strength and sufficient resistance to thermal loading that may occur during casting.

It may also be advantageously provided that the reinforcing element is aligned concentrically in relation to an axis of symmetry of the fluid encapsulation.

Pressure-resistant fluid encapsulations often comprise portions which are of a tubular form. Tubular portions are, for example, hollow-cylindrical arrangements with a cross section in the form of a circular ring. Concentric alignment with the axis of symmetry makes it possible to absorb forces by diverting them into a lateral surface over arcuate paths. In this way, concentrically arranged reinforcing elements can transfer high forces.

It may also be advantageously provided that the reinforcing element comprises a continuous loop.

Loops may be formed, for example, by repeatedly winding, and also partially overlapping, an elongate reinforcing element. Loops may in this case be formed with one or more layers, it being possible for the individual turns of the loop to be in contact with one another or else to be spaced apart. A loop may, for example, also be a continuous ring, possibly with a break in the annulus.

It may also be advantageously provided that the reinforcing element comprises a helicoidal portion.

A helical, that is to say helicoidal, shape makes it possible to provide longer, continuously running-around portions with a reinforcing element.

It may also be advantageously provided that the reinforcing element acts as a tie rod.

A tie rod makes it possible, in particular along linear axes, that forces can be absorbed and distributed between points of attachment of the tie rod. Such tie rods are particularly suitable for distributing forces within the pressure-resistant fluid encapsulation along an axis of symmetry or longitudinal axis.

It may also be advantageously provided that the reinforcing element comprises a meshed portion.

Meshed laying of a reinforcing element makes it possible to make a large number of surfaces available in a large area. Meshing may be produced, for example, by creating a grid or a gauze around which the cast material is cast. The grid meshing may advantageously be at least partially enclosed by the cast material. For example, it is possible to form a meshed portion in such a way that the desired shaping of the pressure-resistant fluid encapsulation is predetermined. For example, it is possible to create a wire grid which is made in the manner of a collar, in order for example to strengthen cast-on stubs, which are located for example on the lateral surface or on the end faces, and so in particular to strengthen points on the pressure-resistant fluid encapsulation that form shoulders.

The meshed portion of the reinforcing element may in this case be designed in such a way that the entire fluid encapsulation is prefabricated in the manner of a wire-grid pattern and is subsequently encased by the metallic cast material. It may, however, also be provided that only portions comprising regions of the cast wall that are particularly subjected to mechanical loading are strengthened with a meshed portion.

Hereafter, an exemplary embodiment of the invention is schematically shown in a drawing and is described in more detail below.

In the drawing:

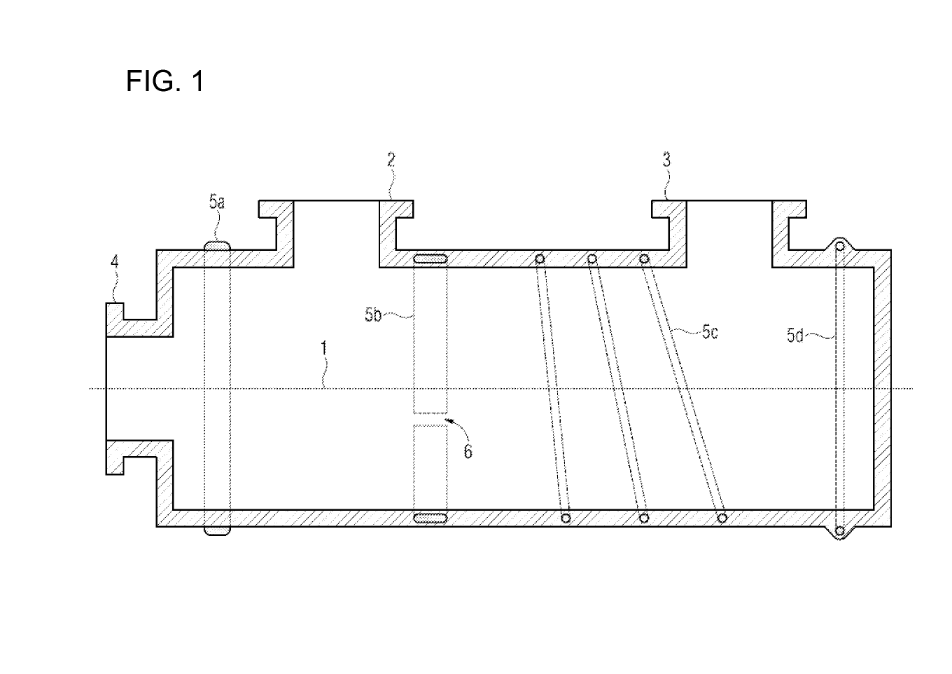

FIG. 1 shows a section through a pressure-resistant fluid encapsulation,

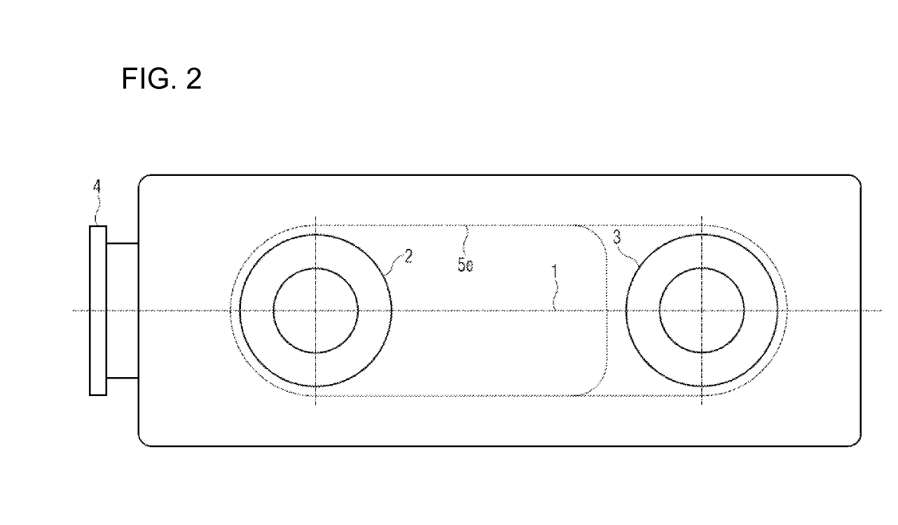

FIG. 2 shows a plan view of the pressure-resistant fluid encapsulation known from FIG. 1,

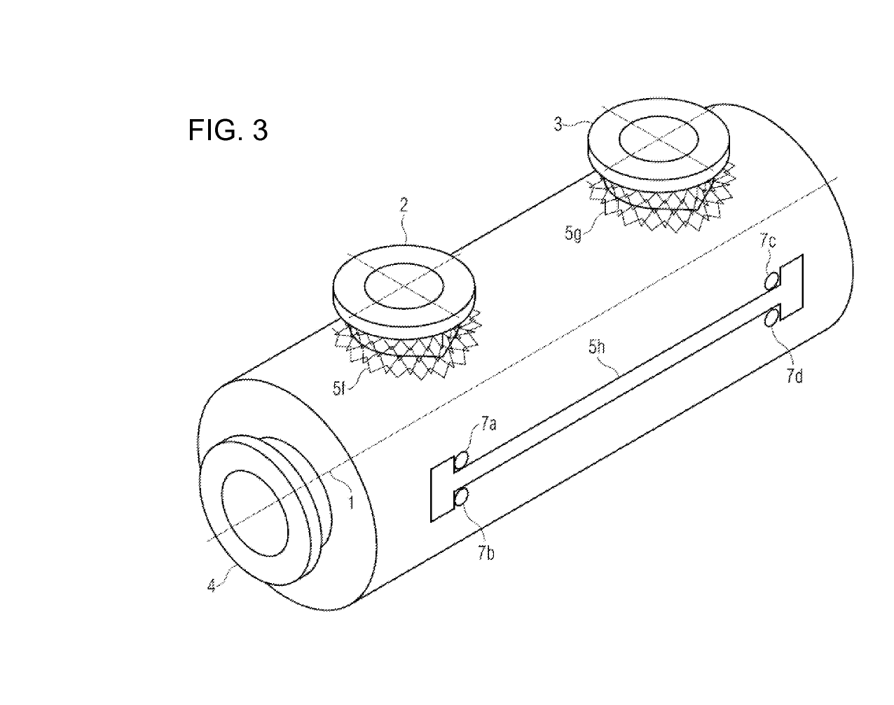

FIG. 3 shows a perspective view of the pressure-resistant fluid encapsulation known from FIG. 1 and

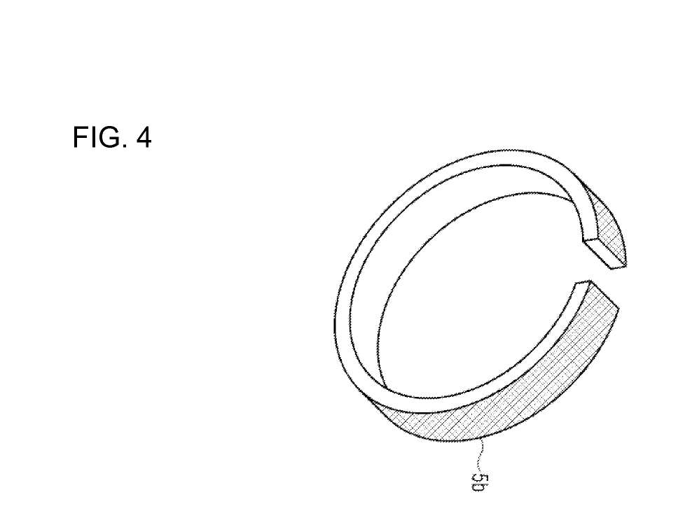

FIG. 4 shows a reinforcing element with a structured surface.

FIG. 1 shows a pressure-resistant fluid encapsulation in a cross section. The pressure-resistant fluid encapsulation has a substantially tubular structure with a cross section in the form of a circular ring, which is aligned coaxially in relation to a longitudinal axis 1. The longitudinal axis 1 represents an axis of symmetry. The pressure-resistant fluid encapsulation is provided on the lateral surface with a first and a second flange 2, 3. Furthermore, a third flange 4 is arranged on a first end face. The third flange 4 is in this case aligned coaxially in relation to the longitudinal axis 1, whereas the first flange 2 and the second flange 3 are aligned substantially in a radial direction in relation to the longitudinal axis. On the second end face, facing away from the first end face, a terminating wall is arranged. For carrying the flanges 2, 3, 4, a substantially hollow-cylindrical casting is provided. The pressure-resistant fluid encapsulation described above is produced in one piece in a casting process, so that all the walls and the flanges 2, 3, 4 are cast walls. In the present case, the cast wall is a metallic cast wall, aluminum or an aluminum alloy being used as the metal. The pressure-resistant fluid encapsulation has in the present case a substantially tubular structure, aligned coaxially in relation to the longitudinal axis. The pressure-resistant fluid encapsulation encloses an inner volume, which can be filled with an electrically insulating gas. In order to avoid volatilization of the electrically insulating gas, the flanges 2, 3, 4 should each be closed in a fluid-tight manner. The interior of the pressure-resistant fluid encapsulation may be additionally provided with electrical phase conductors, which may have current flowing through them. The electrical phase conductors are supported on the pressure-resistant fluid encapsulation in an electrically insulated manner. Solid insulators, for example, are used for this purpose. The electrically insulating gas within the pressure-resistant fluid encapsulation may be subjected to an increased pressure, so that a compressed-gas insulation is formed inside the pressure-resistant fluid encapsulation. In order to establish electrical contact for phase conductors located within the pressure-resistant fluid encapsulation, corresponding pressure-resistant and fluid-tight insulator lead-throughs may be arranged at the flanges 2, 3, 4. The insulator lead-throughs then act together with a phase conductor portion passing through them to close the flanges 2, 3, 4 of the pressure-resistant fluid encapsulation. The pressure-resistant fluid encapsulation hermetically seals an enclosed space, which in the present case is filled with an increased-pressure, electrically insulating gas and phase conductors kept electrically insulated therein.

In the present case, the pressure-resistant fluid encapsulation is designed as a one-piece cast body, reinforcing elements being positioned on the pressure-resistant fluid encapsulation for strengthening.

By way of example, a first reinforcing element 5a is provided in FIG. 1, in the form of a ring on the outer lateral surface, i.e. outside the space closed off by the pressure-resistant fluid encapsulation, resting on an outer surface of the cast wall. The first reinforcing element 5a acts in the manner of a bandage which runs continuously around the first longitudinal axis. A non-magnetic material may be used, for example, as the material for the first reinforcing element 5a, or an electrically insulating synthetic or glass fiber may be used.

Furthermore, a second reinforcing element 5b is arranged on the pressure-resistant fluid encapsulation. The second reinforcing element 5b is likewise designed in the form of a ring, a break 6 being arranged within the ring. The break 6 is a slit, which is passed through by the cast material, here aluminum. As a result, an inhomogeneity is created within the second reinforcement 5b, thereby inhibiting formation of eddy currents. In the present case, the second reinforcing element is completely embedded in the cast wall, i.e. the second reinforcing element is completely encapsulated by the cast wall. However, it may also be provided that a reinforcing element is only partially encased by the cast wall, i.e. only a portion thereof is encased, or portions of the surface of the second reinforcing element 5b protrude out of the cast wall.

A third reinforcing element 5c in the present case takes the form of a helix, the helix running around the longitudinal axis 1. The third reinforcing element 5c may, for example, be designed in the form of a helically coiled steel wire.

Also represented in FIG. 1 is a fourth reinforcing element 5d, which is likewise completely enclosed by the cast wall, the cast wall comprising a corresponding rib running around in the form of a ring, which protrudes from the surface contour of the pressure-resistant fluid encapsulation and thus additionally brings about a mechanical strengthening of the cast wall of the pressure-resistant fluid encapsulation. In the present case, an annular structure of the fourth reinforcing element 5d is provided, the ring being continuous. For example, the ring may be produced from a non-magnetic material.

FIG. 2 shows a plan view of the pressure-resistant fluid encapsulation known from FIG. 1, an alternative design of reinforcing elements being represented. It shows a fifth reinforcing element 5e, which runs in the form of a ring or in the manner of a loop and may rest on the outer surface of the pressure-resistant fluid encapsulation or be at least partially or completely embedded in the cast wall. The fifth reinforcing element 5e, laid in the form of a loop, is in this case aligned in such a way that the loop is not passed through by the longitudinal axis, so that the fifth reinforcing element 5e lies with its loops or its loop in a curved form in/on the lateral surface, and the pressure-resistant fluid encapsulation is stabilized in a shell-like manner. In the present case, in FIG. 2, the fifth reinforcing element 5e is of a two-loop design, a first loop running around the first and second flanges 2, 3 and a second loop running only around the first flange 2.

FIG. 3 shows a further design of the pressure-resistant fluid encapsulation known from FIGS. 1 and 2, a sixth and a seventh reinforcing element 5f, 5g being provided. The sixth and seventh reinforcing elements each comprise a meshed portion, the meshed portion having a large number of loops and/or meshes and/or apertures and/or grids, which are inserted in the hollow-cylindrical castings of the first and second flanges 2, 3 located on the lateral surface. The meshed portion may in a general form be referred to as a sheet-like gauze, which is preferably completely enclosed/embedded in the cast wall. The meshed portion of the sixth and seventh reinforcing elements 5f, 5g stabilizes the shoulders located at the hollow-cylindrical castings of the pressure-resistant fluid encapsulation, making it more difficult for the first and second flanges 2, 3 and the castings carrying them to be torn off.

Also represented in FIG. 3 is an eighth reinforcing element 5h. The eighth reinforcing element 5h is formed in the manner of a tie rod, the tie rod having a linear extent which is designed to be substantially parallel to the longitudinal axis 1. The eighth reinforcing element 5h braces a cast wall on the lateral side of the pressure-resistant fluid encapsulation and stabilizes the pressure-resistant fluid encapsulation in the longitudinal direction.

In the present case, the eighth reinforcing element 5h is placed on the outer lateral surface. For fixing the eighth reinforcing oddment 5h, fastening means 7a, b, c, d are provided at each of its ends, having the effect of bracing the eighth reinforcing element 5h against an outer surface of the pressure-resistant fluid encapsulation. Clamping bolts, screws, rivets or the like may be provided, for example, as fastening means 7a, b, c, d. However, shoulders which are formed onto the outer surface and behind which equal and opposite shoulders on the ends of the eighth reinforcing element 5h are hooked in, while elastically deforming the eighth reinforcing element 5h, may also serve as fastening means.

FIG. 4 shows a perspective view of the second reinforcing element 5b known from FIG. 1. The second reinforcing element 5b is given the form of a ring, a break being located within the ring in order to prevent eddy currents from occurring in the second reinforcing element 5b. Alternatively, it may also be provided, for example, that non-magnetic materials are used for forming a continuous ring of a reinforcing element. The outer surface of the second reinforcing element 5b is provided with a structure having a large number of notches or elevations, so that an intimate interconnection between the created cast wall and the second reinforcing element 5b is formed when the second reinforcing element 5b is encapsulated with liquid aluminum. This makes a relative movement of the reinforcing elements and the cast wall more difficult.

The designs shown in the figures should be understood as merely given by way of example. In particular, the choice of material, form, structure, position, etc. may vary. In particular, the position and shaping of the reinforcing elements 5a, 5b, 5c, 5d, 5e, 5f, 5g, 5h and their position, in or partially in a cast wall, may be adapted according to the mechanical loads expected.

1-12. (canceled)

13. An explosion-proof fluid enclosure, comprising:
a cast wall formed of a first metal; and
at least one reinforcing element configured to mechanically strengthen said cast wall and formed of a material that is different from said first metal.

14. The explosion-proof fluid enclosure according to claim 13, wherein the first metal of said cast wall is aluminum.

15. The explosion-proof fluid enclosure according to claim 13, wherein said reinforcing element is at least partially embedded in said cast wall.

16. The explosion-proof fluid enclosure according to claim 13, wherein said reinforcing element rests on said cast wall.

17. The explosion-proof fluid enclosure according to claim 13, wherein said reinforcing element runs around in a form of a ring, and wherein a short circuit following a path of said ring is interrupted by a break or an inhomogeneity of the material.

18. The explosion-proof fluid enclosure according to claim 13, wherein at least a portion of a surface of said reinforcing element has a surface-increasing structure.

19. The explosion-proof fluid enclosure according to claim 13, which comprises fastening means disposed endside and connecting said reinforcing element to the fluid enclosure.

20. The explosion-proof fluid enclosure according to claim 13, wherein said material that is different from said first material comprises a metal, an organic plastic, or glass.

21. The explosion-proof fluid enclosure according to claim 20, wherein said metal of said reinforcing element is steel.

22. The explosion-proof fluid enclosure according to claim 20, wherein said organic plastic of said reinforcing element is an aramid fiber.

23. The explosion-proof fluid enclosure according to claim 13, wherein said reinforcing element comprises glass fiber.

24. The explosion-proof fluid enclosure according to claim 13, wherein said reinforcing element is aligned in concentric relationship with an axis of symmetry of the fluid enclosure.

25. The explosion-proof fluid enclosure according to claim 13, wherein said reinforcing element comprises a continuous loop.

26. The explosion-proof fluid enclosure according to claim 13, wherein said reinforcing element comprises a helicoidal portion.

27. The explosion-proof fluid enclosure according to claim 13, wherein said reinforcing element is effective as a tie rod.

28. The explosion-proof fluid enclosure according to claim 13, wherein said reinforcing element comprises a meshed portion.
